(19) United States
(12) Patent Application Publication
(10) Pub. No.: US 2026/0281499 A1
(43) Pub. Date: Sep. 17, 2026

(54) FACE-RECOGNITION METHODS AND SYSTEMS FOR DETERMINING USER BEHAVIOURAL RESPONSE

(71) Applicant: Realeyes OÜ, Tallinn Harju (EE)

(72) Inventor: Elnar Hajiyev, Tallinn Harju (EE)

(73) Assignee: Realeyes OÜ, Tallinn Harju (EE)

(21) Appl. No.: 19/471,495

(22) PCT Filed: Mar. 13, 2024
(86) PCT No.: PCT/EP2024/056657

§ 371 Date: Oct. 1, 2025

(30) Foreign Application Priority Data
Apr. 3, 2023 (GB) 2304938.0

(51) Int. Cl. H04N 21/442; G06V 10/82; G06V 40/16; G06V 40/20

(52) U.S. Cl. CPC H04N 21/44218; G06V 10/82; G06V 40/171; G06V 40/172; G06V 40/174; G06V 40/20

(57) ABSTRACT

Systems and methods for determining user behavioural response during media content consumption are provided. Such methods comprise: obtaining response data including one or more video streams depicting facial images of a user; using a facial recognition protocol to obtain an identifier tag for the user based on the facial images depicted in the one or more video streams; associating the facial images of the user with the identifier tag; and determining a behavioural response of the user to the consumed media content based on the identified one or more facial features of the user and the associated tag. The tag can be used as a unique identification label indicative of the user's identity. The determined behavioural response of the user is determined as a behavioural response data stream that is associated with the tag. Such systems comprise: a collection module communicatively linked via a network to a plurality of client devices; and an analysis module communicatively linked to the collection module. Said system is configured to implement the methods disclosed herein.

### FIELD OF THE INVENTION

The present invention relates to a computer-implemented system and method of determining user reaction to media content. In particular, the invention relates to a computer-implemented system and methods for determining a user's attentiveness or emotional state in reaction to their consumption of media content.

### BACKGROUND

Certain types of media content, such as advertising, music videos, movies, etc., aim to induce changes in a consumer's emotional state. For example, they may aim to catch a user's attention or otherwise increase their attentiveness. In the case of advertising, it may be desirable to translate this change in emotional state into performance, such as a sales lift. For example, a television commercial may look to increase sales of a product to which it relates. There is therefore a demand for being able to evaluate the effectiveness of media content prior to publication.

Active feedback, which may also be referred to as self-reported feedback, can sometimes be used in attempts to determine or predict the performance of pieces of media content, such as video commercials, in terms of how effective the user consciously believes the media content to be. For example, the users may complete a questionnaire, or may provide spoken feedback that can be recorded for analysis, either manually or in an automated manner using speech recognition tools. Feedback could include an indication of an emotional state experienced while consuming the piece of media content. However, such active feedback from users is based on rationalised, conscious thought processes, rather than the (passive) emotional state that the user actually, and possibly subconsciously, experiences.

It is known that a user's preferences, and genuine emotional response, are outside of the user's conscious awareness, and are strongly influenced by the user's passive emotional state. Media content performance therefore cannot be accurately predicted using active emotional state feedback.

It is further known that emotional state data can also be measured in a passive manner, e.g., by collecting data indicative of a user's behavioural or physiological characteristics—for example, while the user consumes a piece of media. In one example, facial responses can be used as passive indicators of experienced emotional state. Webcam video acquisition can be used to monitor facial responses, by capturing image frames as a piece of media content is consumed by a user. Emotional state can therefore be captured via webcams, by processing video images.

Physiological parameters can also be good indicators of a user's experienced emotional state. Many physiological parameters are not consciously controllable, i.e., a user can have no influence over them. Such parameters can therefore be used to determine the true emotional state of a user consuming a piece of media content, which can—in principle—be used to accurately predict media content performance. Examples of physiological parameters that can be measured include voice analysis, heartrate, heartrate variability, electrodermal activity (which may be indicative of arousal), breathing, body temperature, electrocardiogram (ECG) signals, and electroencephalogram (EEG) signals.

Emotional state information may also be measured using personal wearable or portable devices equipped with functionality to record physiological parameters of the type described above. Emotional state information measured in this way is known to correlate with media content performance, in particular sales lift following successful advertisement. In some examples, this emotional state information may (audio)visual data collected through the use of webcams on personal devices.

The behavioural characteristics of a user may manifest themselves in a variety of ways. References to “behavioural data” or “behavioural information” herein may refer to visual aspects of a user's response. For example, behavioural information may include facial response, head and body gestures or pose, and gaze tracking. In practice, it can be desirable to use a combination of raw data inputs comprising behavioural data, physiological data and self-reported data in order to obtain emotional state information. A combination of raw data from two or three of the sources mentioned above may be useful in identifying so-called “false” indicators. For example, if emotional state data derived from all three sources overlaps or is aligned, it gives more confidence in the obtained signal. Any inconsistency int eh signal may be indicative of a false reading.

Furthermore, some types of data may indicate only presence or absence of an emotion or attentiveness, but not the opposite. For example, a response with a variety of facial expressions may indicate high levels of attentiveness. However, the absence of changing facial expressions does not mean low levels of attentiveness. Similarly, a constantly changing head pose may indicate low levels of attentiveness, but a fixed head pose does not necessarily mean high attentiveness.

However, the same facial expression, or series of facial expressions, may be indicative of different emotional and/or behavioural responses for different users. It is, therefore, important to be able to distinguish between different users consuming the media content and to tailor any determination of their behavioural response to particular characteristic behaviours and/or physiological responses of said user.

The present invention has been devised in light of the above considerations.

### SUMMARY OF THE INVENTION

In a general sense, the present invention provides systems and methods for collecting and tagging response data, that includes one or more video streams that depict at least one user's face in such a way that each user depicted in the one or more video streams is effectively tagged, based on implementing a facial recognition protocol to identify facial features of each user. This data, once collected is used to more effectively and accurately analyse the response data to determine a behavioural response of each of the users depicted in the one or more video streams, and/or may be used to better train models (e.g., machine learning models) to be able to determine the behavioural response of a user in a way that takes into account identity information of the user, said identity information being derivable from the facial features identified in the one or more video streams.

In other words, the present invention provides face-recognition systems and methods that leverage the utility of face-recognition algorithms to tag and track behavioural data streams, and determine those behavioural data streams in a manner that is cognisant of how particular identity information of the user may impact the determination of their behavioural data stream.

In a first aspect, there is provided a method of determining user behavioural response during media content consumption, the method comprising: obtaining response data including a video stream depicting facial images of a user; using a facial recognition protocol to obtain an identifier tag (also referred to herein simply as a “tag”) for the user from one or more of the facial images depicted in the video stream; associating the facial images of the user with the identifier tag; determining a behavioural response of the user to the consumed media content based on the facial features of the user and the associated identifier tag, and generating a behavioural response data stream using the determined behavioural response, wherein the behavioural response data stream is associated with the identifier tag.

In this way, it is possible to not just determine a user's behavioural response to media content that they are consuming, but it is also possible to correlate that behavioural response with a specific user that can be identified in later response data collection runs. In this way, particularly in examples where determining the user behavioural response data stream includes implementing a model (e.g., a machine learning model), this is particularly beneficial because it enables the model to be refined, re-trained and/or improved to determine user behavioural response, either for the same user on later response data collection runs, or for other users that are determined as having similar facial features to a previous user.

In some examples, the determined behavioural response may be an attentiveness or an emotional response to the media content being consumed.

The attentiveness or emotional state of the user, and other behavioural responses of the user may be understood with reference to earlier patent applications: ‘Systems and Method for Collecting Data to Assess Effectiveness of Displayed Content’ and ‘Computer-implemented System and Method for Determining Attentiveness of User’ published as WO 2021/028463 A1 and WO 2019/234017 A1 respectively.

In some examples, the tag may be a user ID number, or a unique username of the user. Preferably the tag is a unique identification label indicative of the user's identity. In some examples, the tag may be a label, a text string, a bit string, or data in another similar format that is suitable for serving as an identifier of the user.

In some embodiments, the method may further comprise: storing the tag in a memory such that if further response data is obtained including one or more further video steams depicting facial images of the same user, the facial images depicted in the one or more further video streams and the corresponding behavioural response data stream are associated with the stored tag.

In this way, it is possible to generate, over time, a compiled dataset indicative of the user's behavioural response to various different pieces of media content consumed of several response data collection runs. In this way, it may be possible to obtain correlations between different pieces of media content based on the different determined behavioural responses of the user. Additionally, it may make it possible to compare overall trends in behavioural responses between different users across several different pieces (and types) of media content, and over time.

In some embodiments, the method may further comprise generating the tag to be associated with the user based on the identified one or more facial features.

For example, the tag may be defined by a vector comprising a plurality of vector components. Each of the vector components may correspond to a respective one of the identified one or more facial features. In other words, each of the identified one or more facial features may be encoded as a separate vector component of a vector defining the tag. In this way, similarity between different users may be extracted based on the proximity of each user's tag in the n-dimensional vector space inhabited by the corresponding vectors.

For example, the method may include generating a new tag if it is determined that the user has not been previously tagged in a previous response data collection run. The method may also include associating a previously generated tag with the identified facial features and/or determined behavioural response data stream of a user if it is determined that said user has previously been tagged in an earlier response data collection run.

In this way, new users can be registered with a system carrying out the methods disclosed herein, while pre-existing users can be effectively logged in to such a system thereby ensuring that data collected from a single user can be compiled together so that any links between different response data collection runs can be made to improve the accuracy and effectiveness of the model (or models) used to determine the behavioural response(s) of the user(s) of the system.

In some embodiments, the identifier tag may be useable as a unique identification label indicative of the user's identity.

In some embodiments, the method may include a preliminary registration process in which the user sets up a user account in a system configured to collect the response data. The registration process may for example require the user to provide or set up login details, e.g. username, email address, etc. The registration process may include using the facial recognition protocol to obtain the identifier tag, which can be stored in relation to the user account and used to compared with identifier tag(s) that are subsequently obtained for response data obtained for the user account.

In some embodiments, the associated tag may include information received from the user indicative of their consent for the response data including one or more video streams depicting facial images of them to be used in the determining of a behavioural response.

Data security and data privacy are key considerations in the modern landscape of personal data collection and processing. As such, it is desirable to obtain a user's consent before collecting and/or processing video streams that depict images of their face.

In some examples, the user may be required to provide consent for their facial images to be captured in a video stream prior to the response data being obtained.

In other examples, the user may be required to provide consent for their facial images to be processed to determine their behavioural response after the response data has been obtained. If the user does not provide consent (e.g., passively by not providing the consent, or actively by indicating non-consent), the response data may be discarded.

In some examples, the user may provide their consent for their data to be used anonymously (i.e., for the determined behavioural response data to not be associated with information that could be used to legally identify the user). In other words, the determined behavioural response data stream may not be associated with one or more of: a name, address, job title, employment status, marital status, or medical information associated with the user.

In some examples, the user may provide their consent for their determined behavioural response data stream to be associated with such personal identifying information.

In some examples, the user may provide their consent for the methods to be implemented only in certain contexts. For example, the user may set certain criteria according to which their consent is provided including e.g., an identity of the entity collecting and/or determining their behavioural response data stream, a purpose for which the behavioural response data stream is being determined, and/or the identity or identities of the one or more entities who will be provided with eventual access to their determined behavioural response data stream.

An advantage of obtaining the user's consent to the use of facial images and facial recognition is that it enables the data collection process to confirm that there is a human present at the device from which data is being collected. Purely text-based data collection mechanisms can be vulnerable to misuse, e.g. by using chatbots or the like to mimic human responses.

In some embodiments, if the identified one or more facial features correspond to a previously tagged user, the method may further comprise: terminating the method before determining the behavioural response of the user. For example, the method may further comprise: comparing the identifier tag with a plurality of stored tags, wherein each of the plurality of stored tags is associated with a previously tagged person; and, if the identifier tag corresponds to a stored tag associated with a previously tagged person, terminating the method before determining the behavioural response of the user. The plurality of stored tags may each be associated or otherwise linked to a user account. The method may thus avoid collecting response data for the same user via different user accounts. This functionality may be useful to prevent fraud, e.g. in a scenario in which users are paid for participation.

In cases where the tag is defined by a vector in an n-dimensional vector space, with each component of the vector being defined by an encoding of a respectively different facial feature, determining that a user has or has not been previously tagged may involve determining a similarity between the vectors defining the newly identified user, and one or more of the vectors defining previously stored tags that correspond to previously identified users. Determining the similarity between two vectors may, for example, be based on determining a cosine similarity between the two vectors and/or by determining another suitable similarity metric. It may be determined that two vectors correspond to the same user if the determined similarity metric (e.g., the cosine similarity) exceeds a predetermined threshold. This predetermined threshold may be independently adjustable by an administrator of a system implementing the methods disclosed herein. Conversely but equivalently, it may be determined that two vectors correspond to different users if the determined similarity metric (e.g., the cosine similarity) is below a predetermined (optionally adjustable) threshold. By having a threshold that may be less than perfect correspondence (e.g., a cosine similarity of less than 1) it may be possible to recognise that a user imaged from two different angles is nonetheless the same user. In such contexts, the process of identifying one or more facial features of the user and associating a tag with the facial images of the user may be recognised as the implementation of a face-recognition process.

In some contexts, the creators of the media content (e.g., creators of an advert) may wish to test the efficacy of their content on a group of users, in the form of a focus group or similar, before publicising the content and deploying it more widely. In such contexts, users may feel incentivised—for example, because the content creators are paying users to test the efficacy of the content—to create multiple user accounts and provide response data multiple times. This causes the content creators two significant issues: firstly, the content creators are, in effect, defrauded by such users because they are paying a single user multiple times to provide the same behavioural response data; and secondly, if any one user if able to provide their behavioural response data multiple times, it risks biasing the overall determined behavioural response towards that user. In this way, the result of the determined overall efficacy of the media content may be skewed towards that user and therefore be inaccurate or unrepresentative of the efficacy of the media content in general.

Additionally, in situations where response data for a large number of users is being collected, if the same user is able to provide response data (and therefore eventual behavioural response data streams) multiple times, data storage capacity—in the form of the memory of one or more processors—is consumed and wasted on redundantly collected data.

It is therefore desirable, in contexts such as these, to prevent a single user from being able to provide response data to the same media content multiple times. As described above, this may be done by terminating the methods disclosed herein and discarding the acquired response data to avoid storing redundant data and wasting memory space.

In some embodiments, if the identified one or more facial features correspond to a previously tagged user, the method may further comprise: associating the determined behavioural response of the user with a previously determined behavioural response of the user that has been determined on previously obtained response data.

In this way, it is possible to retain the obtained storage data but ensure, as discussed above, that a compiled dataset indicative of the user's behavioural response to various pieces of media content over the course of several response data collection runs can be generated. By generating this dataset, it is possible for a user of the methods and systems described herein to determine correlations between different pieces of media content based on the different determined behavioural responses of the same user. Additionally, it may make it possible to compare overall trends in behavioural responses between different users across several different pieces (and types) of media content, and to track the trends in behavioural responses for a given user over time.

In some embodiments, the method may further comprise: determining, based on the identified one or more facial features, identity information related to the user. The tag associated with the user may include information indicative of the identity information.

For example, the tag may be generated by compiling the various pieces of identity information for a given user, rendering them in a particular format, and concatenating the rendered pieces of identity information to form the tag.

In some embodiments, the determined identity information may include a determined demographic group associated with the user.

For example, the determined identity information may indicate that the user belongs to a particular demographic based on demographic characteristics. The demographic characteristics for which a user may be classified into a demographic may include one or more of: age bracket, race/ethnicity, and/or gender.

In some embodiments, a user may input identity information, e.g. demographic group information, manually as part of the preliminary registration process to set up a user account. This manually entered information may be cross-checked against information that is extracted by running the facial recognition protocol. For example, the method may comprise extracting demographic group information from the information obtained by using the facial recognition protocol; comparing the extracted demographic group information with identity information input by the user; and generating a notification if the extracted demographic group information does not match the input identity information. The demographic group information may be extracted from or encoded or recorded in the vector that defines the identifier tag. The notification may be provided to the user, e.g. to request them to check or correct their input information. The notification may be provided with the obtained response data, for example to prevent the response data from being categorised into an incorrect demographic group. In one example, this functionality may be used as an age verification tool, e.g. to prevent underage individuals from participating in a behavioural data collection process where there is an age threshold for participation. In some embodiments the method may terminate if the extracted demographic group information does not match with the identity information input by the user.

For example, where the determined demographic group associated with the user is an age bracket, the user may be identified as belonging to a particular age bracket. In such examples, the user may be identified as belonging to an age bracket selected from: 17 or under, 18 to 24, 25 to 34, 35 to 44, 45 to 54, 55 to 64, or 65 or over; or an age bracket selected from: 0 to 1, 1 to 2, 2 to 3, 3 to 5, 6 to 8, 9 to 11, 12 to 14, 15 to 17, or 18 or over; or an age bracket selected from: 0 to 5, 5 to 13, 13 to 18, 18 to 30, 31 to 40, 41 to 50, 51 to 60, 61 to 70, or 71 or over.

For example, where the determined demographic group associated with the user is a race/ethnicity, the user may be identified as belonging to a particular ethnic group. In such examples, the user may be identified based on their skin colour/tone, hair colour, hair texture, and/or eye colour.

In examples where the determined demographic group associated with the user is a gender, the user may be identified as being male, female and/or non-binary.

In some examples, the demographic group (or groups) to which the user belongs may be determined based on a number of different factors. These factors may include one or more of: face shape, bone structure, face feature size and shape (e.g., nose/eye/ear/mouth size and shape), skin tone, hair colour, facial hair presence, style and colour, hair style, hair texture, the presence or absence of wrinkles or age spots or similar, eye colour, and other factors as appropriate.

In cases where the tag is defined by a vector, as discussed above, the user may belong to multiple different demographics of different types (e.g., age bracket, race/ethnicity, gender, etc.) each of the demographics may be identified as being a respective sub-vector of the vector defining the tag. For example, a respective set of one or more components amongst all of the vector components defining the vector may encode the demographic group identity information of the user.

The identity information and/or demographic group may be determined by applying a model, such as a machine model, that is trained—based on a labelled dataset—to infer the correlations between one or more of the factors listed above and the identity information and/or demographic group with which the user is associated. In this way, when the model is applied, it is possible to predict the identity information and/or demographic group(s) associated with the user based on one or more of the factors listed above.

It may be preferable for an administrator of the methods and systems described herein to be able to decide which demographic group(s) or identity information they want to be considered and determined when carrying out the methods described herein. For example, the method may be implemented on a system that incorporates a central administrator interface by which the administrator can indicate which identity information and/or demographic group(s) should be considered and determined for each user.

Additionally or alternatively, it may be desirable for each user for whom response data is collected and for whom identity information is determined to be able to verify that the determined identity information is correct. For example, the response data may be collected by a webcam connected to a computer used by the user, or by a camera integrated with a personal device (e.g., a mobile phone) belonging to the user. Such a device includes a display and/or user interface that may display the determined identity information to the user so that the user can verify that the determined identity information is correct. If any of the determined identity information is considered by the user to be incorrect, they may be provided with an interface to correct the determined identity information so that it is more accurately associated with the user. In examples where the user corrects the determined identity information, the model (such as a machine learning model) that was implemented to determine the identity information may be updated or refined to improve its performance for subsequent iterations. In this way, it may be possible to continually improve the accuracy of the methods and systems disclosed herein as it is used more and more.

In some examples, such as where the tag associated with the user is both a unique identifier of the user and indicative of the identity information (such as the demographic group(s)) associated with the user, the tag may be generated by encoding each element of the user's identity information in an appropriate format, such as a text string, bit string or similar and concatenating these strings to form an overall user ID string. Additionally, the tag may be determined by applying a function, such as a hash function or other similar encoding function, to the overall user ID string to generate a unique identifier associated with the user. In this way, the tag may be both a unique identifier and include information indicative of the user's identity information.

In some embodiments, determining the behavioural response of the user may include determining changes of the behavioural response of the user during the consumption of the media content.

In some examples, it may be particularly desirable to know which parts of the consumed media content elicit particularly strong behavioural responses (e.g., a particularly strong emotional reaction, or increase/decrease in attentiveness). In such instances, this may be determined by monitoring changes in the behavioural response(s) of the user(s) depicted in the one or more video streams that make up the obtained response data.

In some embodiments, the method may further comprise synchronising the behavioural response data stream with the consumed media content.

This may, for example, involve synchronising the behavioural response data stream with a copy of the consumed media content. This copy of the consumed media content may be a part of the obtained response data and may—in some examples—be synchronised with at least one of the one or more video streams that are also a part of the response data.

Synchronising the behavioural response data stream with the response data may be particularly beneficial for determining the efficacy of the consumed media content at eliciting a particular behavioural response, and especially for determining which specific parts of the consumed media content are effective at eliciting such a response based on a comparison between the two synchronised data streams.

In some embodiments, determining the behavioural response of the user may include: applying a pre-trained model to the response data, wherein the pre-trained model is configured to determine the behavioural response of the used based on the identified one or more facial features of the user.

In some embodiments, the method may further comprise: selecting the pre-trained model to be applied to the response data from a group of pre-trained models, wherein the pre-trained model is selected based on the identified one or more facial features of the user and/or the associated tag.

The pre-trained model may be specifically adapted (i.e., trained) to determine the behavioural response for a specific user or category of users. For example, in instances where there are a small number of users consuming the media content, it may be desirable to have a specifically trained model adapted for each user to ensure that the determination of each user's behavioural response is as accurate as possible. In other examples, where there are a large number of users consuming the media content, storing such a large number of pre-trained models may be impractical from a data storage (or data look-up) perspective. In such examples, it may be preferable for each of the plurality of pre-trained models to be specifically adapted (i.e., trained) to determine the behavioural response for a user associated with particular identity information and/or demographic group. In this way, a balance can be struck between improving the accuracy of the determination of the user's behavioural response and reducing the data storage (or data look-up) requirements of the systems disclosed herein.

In some embodiments, the method may further comprise: after determining the behavioural response of the user, verifying the accuracy of the determination; and updating the pre-trained model based on the accuracy.

In this way, the pre-trained model can be updated and refined or retrained as necessary to improve the accuracy of the determination of the behavioural responses for the user (or users) for whom the pre-trained model is adapted to determine behavioural responses to consumed media content.

In some embodiments, the method may further comprise: repeating the identifying of the one or more facial features and the associating of a tag with the facial images of the user; and determining, based on the repeated associating of tags with the facial images, whether the user depicted in the obtained response data changes while the response data is being obtained.

In some embodiments, if it is determined that the user changes while the response data is being obtained, the method may further comprise: terminating the method and discarding the obtained response data.

In this way, it may be possible to discard data for which the behavioural response to the consumed media content cannot be accurately determined because of the change in user during the collection of the response data. As such, it may be possible to avoid needlessly storing response data that is not suitable for use in determining a user's behavioural response to consumed media content.

In some embodiments, if it is determined that the user changes while the response data is being obtained, the method may further comprise: storing the obtained response data in the form of a plurality of response data sets; and determining a respective behavioural response of each user to the consumed media content based on the respectively identified one or more facial features of each user and the respective associated tag. Each response dataset may correspond to response data associated with a different user. Each determined behavioural response of the corresponding user may be determined as a respective behavioural response data stream that is associated with the corresponding tag.

In this way, it may be possible to split the response data into several pieces (each piece corresponding to a different identified user) such that an otherwise corrupted response data stream that would ordinarily be unusable due to it being related to multiple users can be used to determine the behavioural response of each of the users depicted in the response data.

In some embodiments, the one or more video streams may depict facial images of a plurality of users. The method may further comprise, for each user: identifying one or more respective facial features of the respective user based on the facial images of said user; associating the facial images of said user with a respective tag, based on the corresponding one or more facial features; and determining a respective behavioural response of each user to the consumed media content based on the respectively identified one or more facial features of each user and the respective associated tag. Each determined behavioural response of the corresponding user may be determined as a respective behavioural response data stream that is associated with the corresponding tag.

In some embodiments, the method may further comprise: storing each of the associated tags in a memory such that if further response data is obtained including one or more further video streams depicting facial images of any of the same users, the facial images depicted in the one or more further video streams are associated with the corresponding stored tag.

In some examples, multiple users may be imaged in the same video streams making up the response data. In such examples, it is beneficial to be able to determine the behavioural responses of each of the depicted users in parallel using the same response data, as this is more efficient than determining the behavioural responses of each of the users separately one after another.

In some embodiments, the method may further comprise: tracking movements of the tagged facial images in the one or more video streams to track movements of the plurality of users within an environment imaged in the one or more video streams.

In some embodiments, determining a behavioural response of each user may include: applying a pre-trained model to the response data. The pre-trained model may be configured to determine the behavioural response of each user based, at least in part, on one or more of: the respectively identified one or more facial features of said user, one or more properties associated with the movements of said user through the environment imaged in the one or more video streams, and a determined behavioural response of another user amongst the plurality of users, wherein the tag associated with the other user is indicative that the other user is similar to said user.

In some examples, the pre-trained model in this case may be an ensemble model that is generated by compiling, combining, or concatenating a plurality of pre-trained models, each of the respective pre-trained models being adapted or specifically trained to determine the behavioural response of one or more of the plurality of users.

In some examples, the media content may be distributed throughout an environment imaged by one or more video cameras, or similar. For example, the media content may be exhibits in a museum, painting in an art gallery or similar. In such contexts, it may be desirable to track the movements of each of the visitors (i.e., the users) to the environment to understand which parts of the media content in the environment are more and less effective at eliciting a desired behavioural (e.g., emotional response) in visitors (users).

In other examples, the media content may be consumed by multiple users watching the content on, for example, the same screen. The users may be able to, for example, switch seats while consuming the media content and, so it may be advantageous to track the movements of the users across the screen to ensure that the behavioural response data streams determined for each user are accurately associated with each user.

In some examples the one or more properties associated with the movements of the users through the environment may include an amount of time that said user spends being mobile in the environment. For example, in the context of an environment such as a museum exhibit or gallery, the determination of behavioural response for each user may be based on how much time said user spends walking around the gallery compared to how much time said user spends static (e.g., stood still looking at an item in the gallery or exhibit). For example, in some scenarios, a user that spends more time moving through the environment compared to time standing still could be inferred to be spending comparatively less time actively consuming the media content compared to a user that spends more time standing sell. Accordingly, it could be deduced that a user that spends more time mobile has a lower attentiveness in relation to the media content than a user that is relatively more static in the environment. In this way, the amount of time that a user spends being mobile in the environment may be used in determining the behavioural response (including, but not exclusively limited to, attentiveness) of users in the environment.

Additionally or alternatively, the one or more properties associated with the movements of the users through the environment may include a number of times that said user is determined as being stationary based on the tracked movements. In other words, a number of times that the user stops as they move through the environment. For example, in the context of an environment such an exhibit or gallery, the determination of behavioural response for each user may be based on how many of the items of media content within the environment the user actively stops to look at. For example, in some scenarios, a user that stops more often during their movement through the environment could be inferred to be more interested in the media content within the environment than a user that stops fewer times during their movement through the environment. Alternatively, a user that stops relatively few times during their movement through the environment could be inferred to be more interested in the item of media that they specifically stop in the vicinity of than a user that stops more times in the vicinity of many more different items of media content. In this way, the number of times that a user stops during their movements through an environment may be used in determining the behavioural response of users in that environment. Further, the locations within the environment at which a user stops may be useable in the determination of their behavioural response at least because the location may affect which parts of the environment's media content are consumed by the user.

Additionally or alternatively, the one or more properties associated with the movements of the users through the environment may include a speed (e.g., an average or a maximum speed) at which said user is determined as moving at based on the tracked movements. For example, in some scenarios, a user that moves at a higher average speed through the environment could be inferred to be less engaged with the media content in the environment than a user that moves at a slower average speed through the same environment (possibly because a higher average speed may be indicative that a user is rushing through the environment and not paying as much attention to media content in the environment). In this way, a speed, such as an average speed or maximum speed, of a user as they move through the environment may be used in determining the behavioural response of the user in that environment. In some examples, the speed may be a speed of the user as a whole as they move (e.g., walk) through the environment. In other examples, the speed may be a speed at which the user's head moves as they turn and/or twist to look at different parts of displayed media content—e.g., media content displayed on a screen.

Additionally or alternatively, the one or more properties associated with the movements of the users through the environment may include an amount of time that is spent in the environment being imaged in the one or more video streams. For example, in some scenarios, it may be inferred that a user that spends only a short amount of time in the environment is less interested in the media content within the environment than a user that spends a comparatively longer time in the environment. In contrast however, it may be inferred that the physical and/or physiological responses of a user that has spent a large amount of time in the environment may be different to those of a user that has spent a comparatively shorter amount of time in the environment whilst still conveying a similar emotional response to the media content—for example, this could be due to fatigue of a user that has spent a large amount of time in the environment. Accordingly, the amount of time that is spent in the environment being imaged in the one or more video streams may be used, particularly by an appropriately adapted model (such as a suitably trained machine learning model) to improve the determination of the behavioural response of each of the users in the environment.

In some examples, using tags associated with different users, it may be beneficial to determine similarities between users having similarities, for example similarities in their determined identity information (such as their demographic group(s)). In such instances, if an insufficient amount of data is collected of a particular user's facial features to be able to confidently determine the behavioural response of that user, it may be possible to nonetheless determine the user's behavioural response to the media content by comparing the identified facial features of the user with the identified facial features of another user who is determined as being similar (e.g., in terms of identity information and/or demographic group(s)) to that user, and for whom the behavioural response has been confidently determined. In this way, it may be possible to exploit determinations made in relation to other users within the environment to determine behavioural responses for a user that would otherwise be impossible, impractical, or at least significantly more difficult, complex or costly to determine.

In some embodiments, the response data may include audio data corresponding to the one or more video streams.

The audio data may correspond to a selected one or more of the one or more video streams. That is, some—but not all—of the one or more video streams may have associated audio data.

In such examples, the determining of the behavioural response of users to consumed media content may be further based on the audio data, for example, by including context indicated by audio related to the user (such as sighs, speech, exclamations, and the like) in the factors considered when determining the user's behavioural response to the consumed media content. In this way, it may be possible to improve the confidence in the accuracy oof the determined behavioural response.

In some embodiments, the response data may include metadata indicative of one or more contextual attributes associated with the one or more video streams. The metadata may be useable in determining the behavioural response of the or each user to the media content being consumed.

The metadata may include information related to a type of media content being consumed. For example, the metadata may include information indicative that the media content is e.g., an advertisement, a video, a picture, a drawing, a sculpture, an exhibit, free-form text, or another type of media content suitable for consumption by a user. This information may be useable when determining the behavioural response of the user to the media content because it may be inferred that different behaviours are indicative of different levels of attentiveness and/or emotional state for different types of media content. For example, in the method may involve determining a level of attentiveness based, in part, on a degree of eye movement. In the context of free-form text media content, a large degree of eye movement may be indicative that the user is reading the text, while in the context of a sculpture a large degree of eye movement may be indicative that the user is not interested in the sculpture. Accordingly, determining the behavioural response of the user may involve applying an appropriate model (e.g., a machine learning model) that has been trained to recognise correlations between certain physiological responses (e.g., facial expressions) and the types of media content in such a way as to infer a particular behavioural response based on those correlations.

Additionally or alternatively, the metadata may include information related to information indicative of the content depicted in the media content. In this way it may be possible, when synchronising the behavioural response data stream with the media content (as is done in some embodiments of the methods disclosed herein) to identify which particular parts of the consumed media content (in terms of the subject of the media content being consumed by the user) elicit particular behavioural responses, e.g., in the form of an attentiveness or emotional response.

Additionally or alternatively, the metadata may include a duration of the media content, or a duration over which the media content is consumed by the user (or users). This information may be useable when synchronising the behavioural response data stream with the media content.

Additionally or alternatively, the metadata may include a medium over which the media content is being consumed. For example, the metadata may include information indicative that the media content is being consumed in-person (e.g., an exhibit or gallery), that the media content is being consumed via a personal device, e.g., a mobile device such as a laptop, mobile phone or tablet device, or that the media content is being consumed via a desktop computer. This information may be useable in the determining of the behavioural response of the user (or users) to the media content being consumed because different physiological or physical responses may be expected depending on the medium over which the media content is being consumed. For example, it may be expected that a user consuming media content via a mobile phone will not move their head and face much relative to the camera on the phone (through which the response data is obtained) because the phone screen is relatively small and it is necessary to hold the phone substantially still relative to the user's head so that the user can consume the media content (if they are paying attention to the media content).

In some embodiments, the method may further comprise: determining a quality associated with the obtained response data. The quality may be indicative of whether the obtained response data is suitable for use in determining the behavioural response of the or each user to the media content being consumed. If it is determined that the quality is below a predetermined threshold, the method may further comprise: discarding the obtained response data.

In some examples, the quality may be indicative, for example, of the image quality of the response data. As an example, the quality be indicative of a degree of blurriness of the response data. Additionally or alternatively, the quality may be indicative of whether the user's facial features, as depicted in the response data are occluded or whether those features are clearly visible. Additionally or alternatively, the quality may be indicative of whether a sufficient proportion of the facial features of the user have been identified to be able to determine that user's behavioural response to the consumed media content.

In such examples, if the quality indicates that the response data is too blurry to be able to reliably identify the facial features of the user, and/or if the quality indicates that the user's face is too occluded to be able to identify sufficient facial features of the user, and/or if the quality indicates that an insufficient proportion of the facial features of the user have been identified, then this may be indicative that it is not possible to reliably determine the behavioural response of the user because an insufficient number of facial features can be reliably determined. In such a case, the response data need not be stored because there can be no behavioural response data stream associated therewith.

In some examples, the quality may be indicative, for example, of a likelihood of spoofing in the response data. Spoofing the response data may be understood as replacing a livestreamed video of facial images with a pre-recorded video of facial images and/or a video of a video of facial images. In other words, spoofing may replace genuine video streams with fake or inauthentic video streams. In such cases, spoofed videos may be undesirable as they may be altered to artificially bias or skew the results of determining a user's behavioural response. It is therefore desirable to reject spoofed video streams from processing.

In some examples, the quality of the response data may be determined as a quality score that is representative of an aggregate of a plurality of factors that affect the quality of the response data.

As such, discarding the response data for which the behavioural response data stream cannot be determined provides a more efficient use of the data storage capacity of a system implementing the methods disclosed herein.

In some examples, only portions of the obtained response data that do not pass the quality check described above may be discarded. Meanwhile, portions of the obtained response data that do pass the quality check may be processed according to the methods described herein to determine user behavioural response based on those portions of the obtained response data that did pass the quality check. In this way, it may be possible to balance the efficient use of the data storage capacity of a system implementing the methods disclose herein with the desire to maximise the amount of data on which a behavioural response determination is based.

In some embodiments, the method may further comprise: receiving, from a user, an initiation request based on a tag associated with the one or more identified facial features associated with a user; initiating the obtaining of the response data in response to receiving the initiation request; determining, based on the identified one or more facial features whether the initiation request is received from the same user whose one or more identified facial features are associated with the tag; and, if the user is determined as being a different user from the user whose one or more identified facial features are associated with the tag, terminating the method and discarding the obtained response data.

In other words, the user may be registered with a system (or device) configured to implement the methods disclosed herein. When the user is registered, they may attempt to initiate the methods disclosed herein. The registration includes information indicative of that user's tag from a previous response data collection run, or in some examples, a tag generated as a consequence of the user registering their facial features with the system configured to implement the methods disclosed herein. For example, the user may need to log in with a unique user ID that is associated with or defines the tag associated with their facial features.

Alternatively, if the response data is collected by a user's personal device, such as a mobile phone or a laptop, the initiation request may include in its metadata—e.g., in the form of an IP address or similar—an indication of the identity of the user that owns the device. In this way, the tag may be indicated in the initiation request.

Following the initiation request, it is determined whether the user that is depicted in the one or more video streams contributing to the response data is the same user as the one whose tag the initiation request is based on. If the user depicted in the response data corresponds with the tag that the initiation request is based on, then the remainder of the method can progress and the behavioural response of the depicted user to the consumed media content can be determined. Meanwhile, if the user depicted in the response data does not correspond with the tag that the initiation request is based on, then this is indicative that the user depicted in the response data is not a registered and/or authorised member of the system—at least in the context of that specific initiation request. As the depicted user does not correspond with the user that the initiation request is based on, the method disclosed herein may be terminated, and the obtained response data discarded.

In this way response data for which an associated behavioural response data stream is not determined is discarded to avoid unnecessarily consuming data storage space in a system configured to implement the methods disclosed herein.

Further, in effect, this secures the methods disclosed herein against abuse by a fraudulent user. For example, if an individual acquires the personal device of a user that has registered with a system configured to implement the systems disclosed herein, then such an individual may attempt to fraudulently or illicitly gain access to the system. By terminating the method, it is possible to prevent this fraudulent access, thereby improving the security of the systems and methods disclosed herein. Additionally or alternatively, the model (e.g., the machine learning model) that is used to determine the behavioural response of the user to the consumed media content may not be effective if the user depicted in the response data differs from the user associated with the tag that the initiation request is based on. As such, the determined behavioural response may be inaccurate or unreliable if the user depicted is incorrectly associated with a tag. For this reason, discarding the response data and terminating the determination of the behavioural response may be beneficial because it avoids generating inaccurate behavioural response data streams.

In another aspect, there is provided a system for determining behavioural response during media content consumption. The system comprises: a collection module communicatively linked to a plurality of client devices; and an analysis module communicatively linked to the collection module. The system is configured to implement the methods disclosed herein.

In some examples, the collection module may be communicatively linked to the plurality of client devices via a network, e.g., a wireless network.

In some examples, the collection module may be configured to obtain response data that includes one or more video streams depicting facial images of a user consuming media content. Additionally or alternatively, the analysis module may be configured to identify one or more facial features of the user based on the facial images depicted in the one or more video streams, associate the facial images of the suer with a tag based on the identified one or more facial features, and determine a behavioural response of the user to the consumed media content based on the identified one or more facial features of the user and the associated tag. The determined behavioural response of the user may be determined by the analysis module as a behavioural response data stream that is associated with the tag.

In some examples, the system may further comprise a memory in which the tag can be stored such that if further response data is obtained including one or more further video streams depicting facial images of the same user, the facial images depicted in the one or more further video streams and the corresponding behavioural response data stream may be associated with the stored tag by the analysis module.

In some examples, the analysis module (or another suitable module) may be further configured to generate the tag associated with the user based on the identified one or more facial features.

As discussed above, the associated tag may be useable as a unique identification label indicative of the user's identity.

In some examples, if the identified one or more facial features correspond to a previously tagged user, the analysis module, or a termination module, may be configured to terminate the determination of user behavioural response.

In some examples, if the identified one or more facial features correspond to a previously tagged user, the analysis module may be configured to associate the determined behavioural response of the user with a previously determined behavioural response of the user that has been determined on previously obtained response data and stored in the memory of the system.

In some examples, the analysis module may be configured to determine, based on the identified one or more facial features, identity information related to the user. As discussed above, the tag associated with the user may include information indicative of the identity information.

As discussed above, the determined identity information may include a determined demographic group associated with the user.

In some examples, the analysis module may be configured to determine changes of the user's behavioural response during consumption of the media content.

In some examples, the analysis module may be further configured to synchronise the behavioural response data stream with the consumed media content.

In some examples, the analysis module may be further configured to apply a pre-trained model to the response data. As discussed above, the pre-trained model may be configured to determine the behavioural response of the user based on the identified one or more facial features of the user.

In some examples, the memory may include a model storage section for storing a plurality of pre-trained models, and the analysis module may be further configured to select a pre-trained model from amongst the plurality of pre-trained models based on the identified one o more features of the user and/or the associated tag.

In some examples, the system may further comprise a training module. The training module may, in some examples, be part of the analysis module. The training module may be configured to verify the accuracy of the determination of the user's behavioural response to the consumed media content by the (selected) pre-trained model, and to update the pre-trained model based on the verified accuracy. In other words, the training module may be configured to update, refine and/or retrain the pre-trained models to improve the accuracy and reliability of their determinations of user behavioural response to consumed media content.

In some examples, the analysis module may be further configured to repeatedly identify one or more facial features of the user depicted in the one or more video streams that are part of the response data, and to determine whether the user depicted in the obtained response data changes while the response data is being obtained.

In some examples, if it is determined that the user changes while the response data is being obtained, the analysis module, or a termination module, may be configured to terminate the determination of user behavioural response to the consumed media content.

Alternatively, in some examples, if it is determined that the user changes while the response data is being obtained, the analysis module may be configured to store the obtained response data in the memory in the form of a plurality of response data sets. Each response dataset may correspond to response data associated with a different user depicted in the response data. The analysis module may be further configured to determine a respective behavioural response of each user to the consumed media content based on their respectively identified one or more facial features and the respectively associated tag. Each determined behavioural response of the corresponding user may be determined as a respective behavioural response data stream that is associated with the corresponding tag.

In some examples, the system may comprise one or more video cameras capturing respective video streams of an environment having a plurality of users therein consuming the media content. In such examples, the analysis module may be further configured: to identify one or more respective facial features of each user based on the facial images of said user; associate the facial images of each user with a respective tag, based on the corresponding identified one or more facial features; and determine a behavioural response of each user to the consumed media content based on the respectively identified one or more facial features of each user and the respective associated tag. Each determined behavioural response of each user may be determined as a respective behavioural response data stream that is associated with the corresponding tag.

In some examples, each of the associated tags may be stored in the memory such that, if further response data is obtained including one or more further video streams depicting facial images of any of the same users, then the facial images depicted in the one or more further video streams will be associated with the corresponding stored tag by the analysis module.

In some examples, the analysis module may be configured to track movements of the tagged facial features in the one or more video streams to track movements of the plurality of users within the environment being imaged in the one or more video streams.

In some examples, the analysis module may be configured to apply a pre-trained model to the response data. The pre-trained model may be configured to determine the behavioural response of each user based, at least in part on one or more of: the respectively identified one or more facial features of said user, one or more properties associated with the movements of said user through the environment images in the one or more video streams, and a determined behavioural response of another user amongst the plurality of users, wherein the tag associated with the other user is indicative that the other user is similar to said user.

As discussed above, the response data collected by the collection module may also include audio data corresponding to the one or more video streams. In some examples, the audio data may correspond to a selected one or more of the one or more video streams. That is, some—but not all—of the one or more video streams may have associated audio data.

As discussed above, the response data collected by the collection module may also include metadata indicative of one or more contextual attributes associated with the one or more video streams. The metadata may be useable by the analysis module in determining the behavioural response of the or each user to the consumed media content.

In some examples, the system may further comprise a quality control module. The quality control module may be a separate component from, or be a part of, the analysis module. The quality control module may be configured to determine a quality of the obtained response data. The quality may be indicative of whether the obtained response data is suitable for use in determining the behavioural response of the or each user to the consumed media content. If it is determined that the quality of the response data is below a predetermined threshold, the quality control module may be further configured to discard the obtained response data.

The system may further comprise a user interface. The user interface may be part of one of the plurality of client devices, or may be associated with the collection module. The user interface may be configured to receive a request to determine a user's behavioural response to consumed media content. The request may be used to generate an initiation request received by an initiation module of the system. The initiation request may be based on a tag associated with the one or more facial features associated with a user registered with the systems disclosed herein. The initiation module may be configured, in response to receiving the initiation request, to initiate the obtaining of the response data by the collection module. The initiation module or analysis module may be further configured to determine, based on the identified one or more facial features whether the initiation request is received from the same user whose one or more identified facial features are associated with the tag on which the initiation request is based. If the user is determined as being a different user from the user whose one or more identified facial features are associated with the tag, the analysis module, initiation module or termination module may be configured to terminate the determination of the behavioural response of the user to the consumed media content and discard the obtained response data from the memory of the system.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 depicts a system for use in determining the behavioural response of user or users when consuming media content.

FIG. 2 depicts a method of initiating the determination of a user's behavioural response to consumed media content when the user is a new user of the system of FIG. 1.

FIG. 3 depicts a method of initiating the determination of a user's behavioural response to consumed media content when the user is a pre-existing of the system of FIG. 1.

FIG. 4 depicts a continuation of the method of FIG. 2 or 3 of determining the behavioural response of the user or users to the consumed media content.

FIG. 5 depicts a continuation of the method of FIG. 4 for verifying the accuracy of the determined behavioural response and improving the performance of the system of FIG. 1.

FIG. 6 depicts an additional or alternative continuation of the method of FIG. 4 for synchronising the determined behavioural response data with the media content.

FIG. 7 depicts an additional or alternative continuation of the method of FIG. 4 for storing the determined behavioural response data.

FIG. 8 depicts an additional or alternative continuation of the method of FIG. 4 for responding to a change in the user whose facial images are depicted in the response data.

FIG. 9 depicts a quality control method for assessing the quality of the response data.

FIG. 10 depicts an example of the data structure of the response data.

FIG. 11 depicts an example of the data structure of a tag associated with a user.

FIG. 12 depicts an example of the generation of an ensemble model adapted to determine the behavioural responses of multiple users simultaneously.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

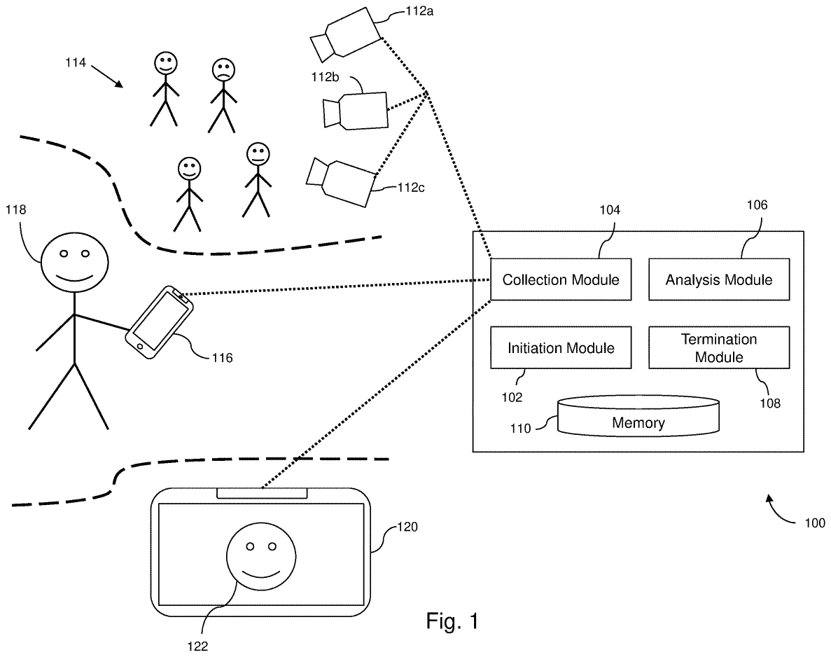

FIG. 1 shows a system 100 for determining the behavioural response of user or users when consuming media content.

The system 102 comprises an initiation module 102, a collection module 104, an analysis module 106, a termination module 108, and a memory 110. Each of the initiation module 102, collection module 104, analysis module, and termination module 108 may be communicatively linked to each other. Additionally, each of these modules 102, 104, 106, 108 may be communicatively linked to the memory 110. For example, the collection module and analysis module may be configured to be able to write data into the memory 110, while the termination module may be configured to be able to delete data from the memory 110.

In the example shown in FIG. 1, the collection module 104 is part of a server side apparatus, and is communicatively connected to a plurality of client devices, for example, via a network (e.g., a wireless network). The client devices include video recording capability to record one or more video streams of user or users consuming media content in an environment of the user. The one or more video streams include facial images of the user (i.e., images of the face(s) of the or each user). In other examples, however, the collection module 104 may be located on the client side of the network. The collection module 104 may be configured as a browser-based tool, e.g. add-on module or the like, or as an app running on a client device.

FIG. 1 shows three example scenarios in which the system may be deployed. In a first scenario, one or more video cameras 112a-c capture video images of one or more users 114 in an environment where they are consuming media content. In a second scenario, the client device 116 is a personal device such as a mobile phone, laptop, or tablet device belonging (or used by) a user 118. In this second scenario, the user 118 is consuming media content that they are watching or looking at on their personal device 116. In a third scenario, the client device 120 is e.g., a computer screen or similar with a webcam recording a user 122 that is consuming media content being displayed on said screen 120.

While three scenarios have been set out above, the skilled person will recognise that the systems and methods disclosed herein may be applied in any situation where one or more video streams depicting facial images of one or more users consuming media content are collected by a suitable client device, and those video streams form part of response data (as discussed in more detail below) communicated to the collection module 104 of the system 100.

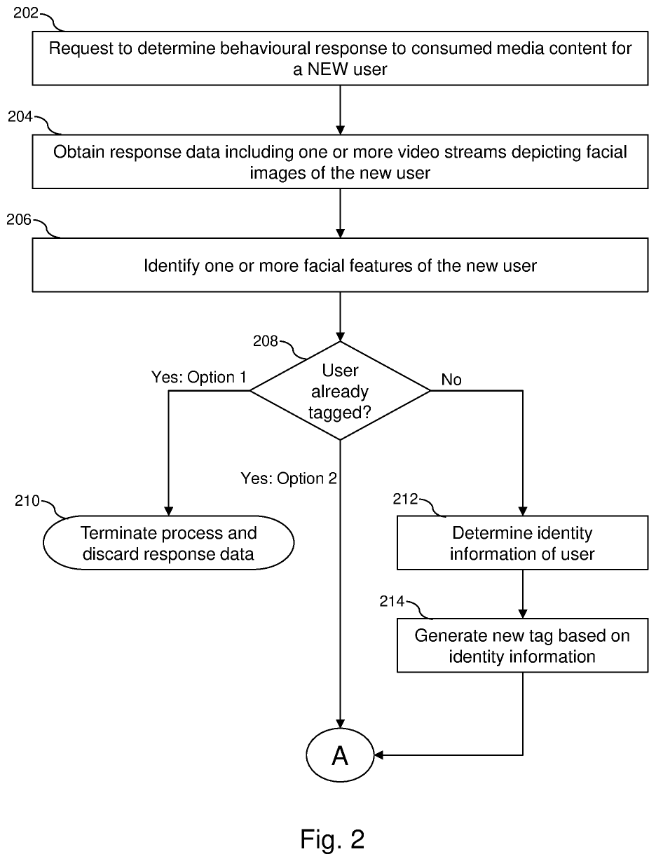

FIG. 2 shows a method of initiating the determination of a user's behavioural response to consumed media content when the user is a new user of the system of FIG. 1.

In a first operation 202, the initiation module 102 may receive a request to determine the behavioural response of a new user to consumed media content. The request may be made by the user or an administrator by interaction with a user interface.

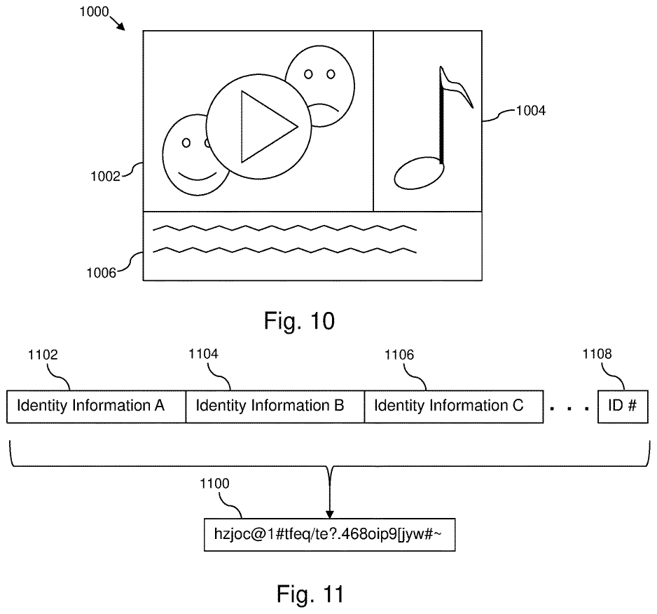

In response to receiving the request, the initiation module 102 may send a command to the collection module 104 to initiate obtaining of response data. The response data, as discussed below in more detail in relation to FIG. 10, at least includes one or more video streams that capture images of the face(s) of the user or users consuming media content (for which a behavioural response is to be determined).

As such, a further operation 204 involves the collection module 104 obtaining response data from the client devices, said response data including one or more video streams depicting facial images of the new user(s) as they consume the media content.

In one example, the collection module 104 communicates the obtained response data to the analysis module 106 for subsequent processing and may store a copy of the response data in the memory 110. In another example, the collection module 104 itself performs some initial processing of the obtained response data, e.g. to ensure that the captured images of the user are not transmitted over the network.

In a further operation 206, the collection module 104 or the analysis module 106 use a facial recognition protocol to obtain an identifier tag for the user from one or more facial images in the video stream. The facial recognition protocol may operate to identify one or more facial features of the user(s). The one or more facial features may include e.g., skin tone; eye shape, size, colour; nose shape, size; ear shape, size; hair colour, style, texture; overall face shape, structure—e.g., jawline, forehead proportion of the new user(s). The facial recognition protocol may be a suitable image recognition algorithm, for example an appropriately trained machine learning model that is trained to identify facial features from still or video images, as required. Where the identifier tag is obtained at the collection module 104, it may be communicated to the analysis module 106 via the network.

Using the obtained identifier tag, the analysis module 106 may be configured to consult a database of tags stored in the memory 110. Each tag may include information indicative of the identified facial features of pre-existing users that have already successfully registered with the system 100 (and possibly have had their behavioural response to consumed media content already determined in accordance with the methods described herein). This consultation may be considered to be a verification operation 208 of whether the supposedly new user requesting determination of behavioural response to consumed media content is in fact a new user, or whether they have already got a tag that is associated with their facial features.

It is possible that multiple different faces are detected within the video stream images of the response data. Accordingly a plurality of identifier tags may be obtained for response data for a given user account. The analysis module 106 may be configured to determine a primary identifier tag for the user account, e.g. depending on one or more of the frequency with which an identifier tag appears (i.e. the primary user is likely to appear most often), the size of corresponding face in the video stream image (i.e. a bigger face indicates a person closer to the device), and the head pose of the corresponding face (i.e. a face directed towards the device is more likely to be consuming the media content). The primary identifier tag may be associated with the user account for the purposes of determining if the correct user is participating in the data collection process. The primary identifier tag may also be used as a security measure for the user account, i.e. user account settings may only be altered by a user having a identifier tag that matches the primary identifier tag.

Furthermore, the ability to obtain a plurality of identifier tags may also assist in ensuring that consent is or has been obtained for all users visible in the video. The system may be configured to link consent obtained for a user with a corresponding identifier tag. The system can cross check the plurality of identifier tags obtained for response data against a list of tags for which consent has been obtained. Where there is no consent associated with a given identifier tag, the system may be configured to terminate data collection associated with that tag and/or take steps to seek consent, especially if the tag is new to the system.

If it is determined that the user does already have a tag associated with their identified facial features, then an administrator of the system may decide how to proceed. As a first option, the administrator may decide to implement a termination procedure 210. Termination procedure 210 may include terminating, by the termination module 108, the process of determining the user's behavioural response to the consumed media content and discarding any obtained response data from the memory 110.

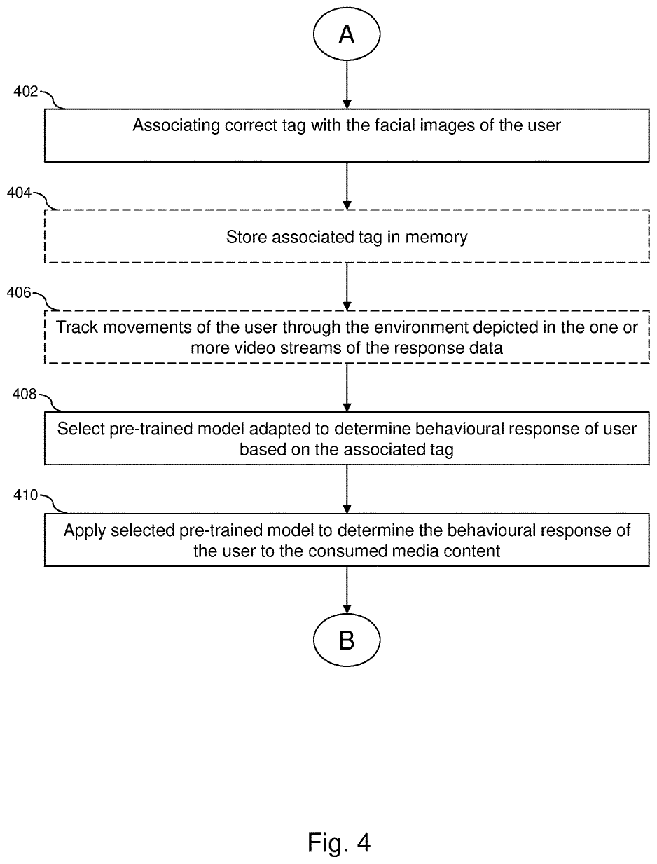

Alternatively, the administrator may decide, despite the fact that the user is not, in fact, a new user to continue with the determination of the behavioural response of the user. This will be discussed in more detail in relation to FIG. 4.

Meanwhile, if it is determined that the user does not already have a tag associated with their identified facial features, and therefore is indeed a new user, then the analysis module 106 may be further configured to determine identity information of the user. For example, the determined identity information may include information about one or more demographic groups that the user belongs to, as discussed above.

Subsequently, the analysis module 106 may be configured to generate a new tag to be associated with the user. This new tag, as will be discussed below in relation to FIG. 11, may include information indicative of the identity information that was determined in operation 212.

Following the generation of the tag, the process for determining the user's behavioural response to the consumed media content may be continued, as will be discussed in relation to FIG. 4.

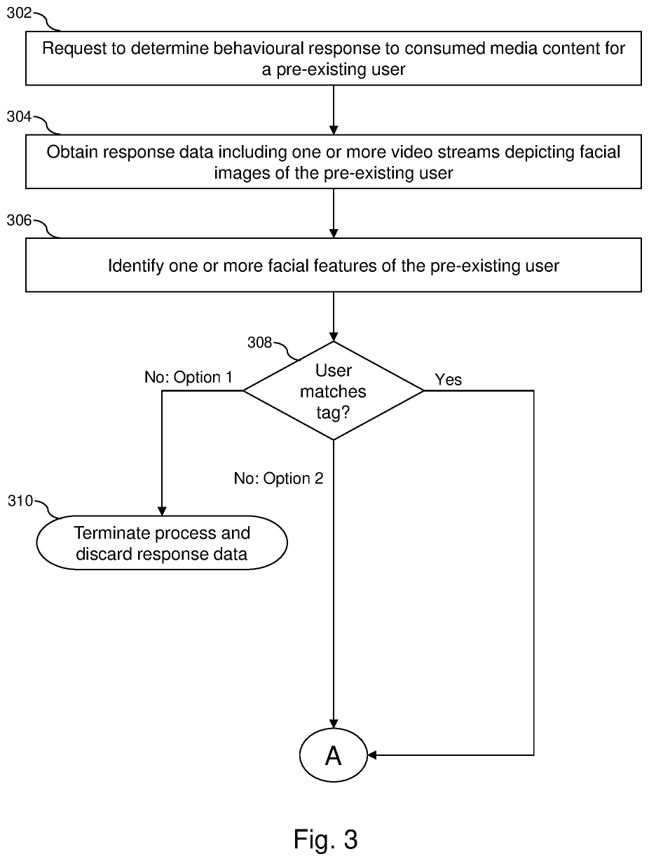

FIG. 3 shows a method of initiating the determination of a user's behavioural response to consumed media content in an alternative situation where the user is a pre-existing user of the system 100.

In a first operation 302, the initiation module 102 may receive a request to determine the behavioural response of a pre-existing user to consumed media content. The request may be made by the user or an administrator by interaction with a user interface.

In response to receiving the request, the initiation module 102 may generate an initiation request to instruct the collection module 104 to begin obtaining response data. The response data (as discussed in above in relation to FIG. 2 and below in relation to FIG. 10) at least includes one or more video streams that capture images of the face(s) of the user or users consuming media content (for which a behavioural response is to be determined).

Generating the initiation request may involve concatenating an identifier associated with the user that sent the request together with their request. In other words, the initiation request may include, in its metadata, an indication of the identity of the user associated with the device that sent a request to the initiation module 102. In some examples the identifier may be the tag that was previously determined, generated and associated with the user by the analysis module 106.

In a further operation 304, the collection module 104—in response to receiving the initiation request from the initiation module 102—obtains response data from the client devices, said response data including one or more video streams depicting facial images of the pre-existing user(s) as they consume the media content. The collection module 104 communicates the obtained response data to the analysis module 106 and may store a copy of the response data in the memory 110.

In a further operation 306, the analysis module 106 identifies one or more facial features of the pre-existing user(s). The one or more facial features may include e.g., skin tone; eye shape, size, colour; nose shape, size; ear shape, size; hair colour, style, texture; overall face shape, structure—e.g., jawline, forehead proportion of the pre-existing user(s). The facial features of the user or users may be identified by implementing a suitable image recognition algorithm, for example by implementing an appropriately trained machine learning model that is trained to identify facial features from still or video images, as required.

Based on the identified facial features, the analysis module 106 may be configured to consult the database of tags stored in the memory 110. Each tag may include information indicative of the identified facial features of pre-existing users that have already successfully registered with the system 100 (and possibly have had their behavioural response to consumed media content already determined in accordance with the methods described herein). This consultation may be considered to be a verification operation 308 of whether the pre-existing user is, in fact, the same user as they claim to be based on their initiation request. In other words, the method includes an operation 308 to determine whether the tag associated with the user based on their initiation request matches the tag associated with the user based on their identified facial features.

If it is determined that the initiation request tag and the facial features tag do not match, then an administrator of the system may decide how to proceed. As a first option, the administrator may decide to implement a termination procedure 310. Termination procedure 310 may include terminating, by the termination module 108, the process of determining the user's behavioural response to the consumed media content and discarding any obtained response data from the memory 110.

Alternatively, the administrator may decide, despite the fact that the initiation request tag and the facial features tag do not match, to continue with the determination of the behavioural response of the user. This will be discussed in more detail in relation to FIG. 4.

Meanwhile, if it is determined that the initiation request tag and the facial features tag do match, then the determination of the behavioural response of the user may continue. This will be discussed in more detail in relation to FIG. 4.

While both FIGS. 2 and 3 describe the initiation of the methods in response to receiving a request from a user or administrator of the system 100, it will be appreciated that this may not always be necessary—for example, the process of determining user behavioural response to consumed media content may be continuous or automatic (e.g., initiated by a user consuming media content without the need to submit a separate request to determine the behavioural response).

FIG. 4 shows a continuation of the method of either FIG. 2 or FIG. 4 of determining the behavioural response of a user or users to consumed media content.

Operation 402 includes associating a correct tag with the facial images of the users whose behavioural response is being determined. For example, if the user is a new user, then the correct tag associated with the user is the newly generated tag, generated in operation 214. If the user is a pre-existing user that attempted to initiate the behavioural response determination process as a new user, then the correct tag is the tag stored in the memory 110 that corresponds to their identified facial features, as identified in operation 206. Meanwhile, if the user is a pre-existing user that attempted to initiate the behavioural response determination process as a pre-existing user, then the correct tag is the tag stored in the memory 110 that corresponds to their identified facial features, as identified in operation 306. The correct tag may therefore be correctly associated regardless of whether the pre-existing used the correct initiation tag to attempt to initiate the behavioural response determination process.

If the tag associated with the facial images of the user is a newly generated tag, then the analysis module 106 (in operation 404) will store a copy of the tag, with information indicative of the facial features with which it is associated, in the memory 110.

In some examples, the location of the user may change relative to the video camera(s) capturing the one or more video streams depicting their face. In other words, the user may move through an environment being imaged by the one or more video cameras. In some circumstances, the location of the user within the environment may be relevant contextual attribute data that is useable in the process of determining the behavioural response of the user to the consumed media content (for example as an input into an appropriately trained machine learning model). As such, in some examples, an operation 406 may involve tracking, by the analysis module 106, movements of the user through the environment depicted in the one or more video streams of the response data.

A further operation 408 involves the analysis module 106 selecting a pre-trained model that is adapted to determine the behavioural response of the user in reaction to the consumed media content. The pre-trained model may be one of a plurality of pre-trained models that is stored in the memory 110 in the form of a library of available pre-trained models. The pre-trained model may be selected based on a number of factors including: the determined identity information (e.g., the determined demographic group) of the user for whom a behavioural response is to be determined, the tracked movements of the user through the environment, any similarity between the user and other pre-existing users for whom a behavioural response has been determined (based on their respectively identified facial features and/or respectively determined identity information), and any contextual attribute data associated with the response data, the consumed media content and/or the environment depicted in the one or more video streams of the response data.

A further operation 410 involves applying the selected pre-trained model to determine the behavioural response of the user to the consumed media content. As discussed above, the selected pre-trained model is specifically adapted (i.e., trained) to determine the behavioural response for that user or category of user to which that user belongs. The pre-trained model is preferably trained using conventional machine learning training techniques including training the model on accurately labelled data. The labelling of the data may be manual or automatic and may implement one or more of the annotation processes set out in earlier patent applications: ‘Systems and Method for Collecting Data to Assess Effectiveness of Displayed Content’ and ‘Computer-implemented System and Method for Determining Attentiveness of User’ published as WO 2021/028463 A1 and WO 2019/234017 A1 respectively.

The determined behavioural response of the user(s) to the consumed media content is determined as a behavioural data stream. Preferably the behavioural data stream is of a length similar to or (more preferably) equal to the length of time over which the media content is consumed. By determining the behavioural response of the user as a behavioural response data stream it is possible to monitor how the behavioural response of the user changes over the time during which they consume the media content.

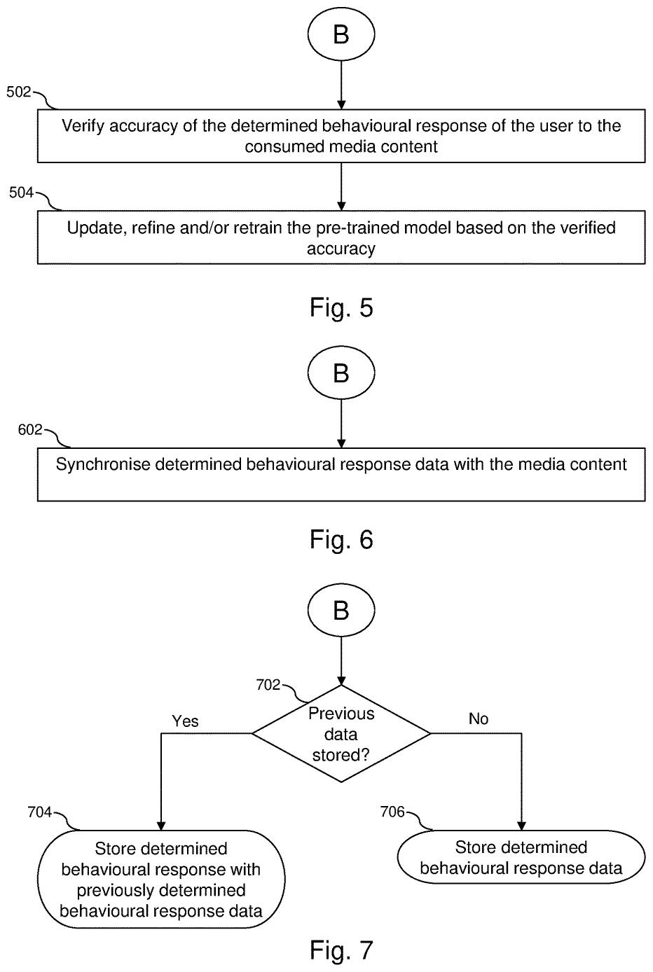

The process of FIG. 4 may continue with a number of process which will be described below in more detail in relation to FIGS. 5 to 8. Each of the methods discussed below in relation to FIGS. 5 to 8 may be carried out independently. Any number or combination of the methods discussed below in relation to FIGS. 5 to 8 may be carried out by a user or administrator of the system 100.

FIG. 5 shows a continuation of the method of FIG. 4 for verifying the accuracy of the determined behavioural response and improving the performance of the system 100 of FIG. 1.

In operation 502, the analysis module 106 may verify (i.e., determine) an accuracy of the determined behavioural response of the user to the consumed media content. This verification may be performed by an administrator or auditor manually checking the determined behavioural response and benchmarking the determination against one or more criteria for assessing the accuracy of the determination. Additionally or alternatively, verifying the accuracy of the determined behavioural response may involve comparing the determined behavioural response with a similarly determined behavioural response, as determined by a benchmarked process (e.g., a trusted model).

Following the verification of the accuracy of the determined behavioural response of the user to the consumed media content, operation 504 includes updating, refining and/or retraining the pre-trained model to improve its accuracy (by a training module—not shown in FIG. 1 which may be a part of or be separate from analysis module 106). This updating, refining and/or retraining may be carried out by implementing any suitable and well-known retraining algorithm, for example a regression algorithm to improve the accuracy of the pre-trained model. The updating, refining and/or retraining of the pre-trained model if it is determined that the accuracy of the pre-trained model is below a predetermined threshold. This threshold may be, for example, 99.9% or less, 99.5 % or less, 99% or less, 97.5% or less, 95% or less, or 90% or less.

FIG. 6 depicts an additional or alternative continuation of the method of FIG. 4 for synchronising the determined behavioural response data with the consumed media content.

Operation 602 involves synchronising, by the analysis module 106, the behavioural response data stream with the consumed media content. The method may further, optionally, involve storing the synchronised data streams in the memory 110 for later access by a user, administrator, or auditor of the system 100.

FIG. 7 depicts an additional or alternative continuation of the method of FIG. 4 for storing the determined behavioural response data.

Operation 702 involves checking whether behavioural response data for that user has been previously determined in accordance with the methods disclosed herein and stored in the memory 110 in a previous iteration of the methods disclosed herein.

If it is determined that behavioural response data for that user has previously been determined and stored in the memory, operation 704 involves storing the newly determined behavioural response data with the previously determined behavioural response data in the memory 110. This may involve, for example, saving the newly determined data to the same directory as the previously determined data, or concatenating the newly determined data into the same file as the previously determined data.

Meanwhile, if it is determined that there is no previously determined behavioural response data for that user stored in the memory 110, then operation 706 involves storing the determined behavioural response data in the memory 110, e.g., in a new file or directory dedicated to that user.

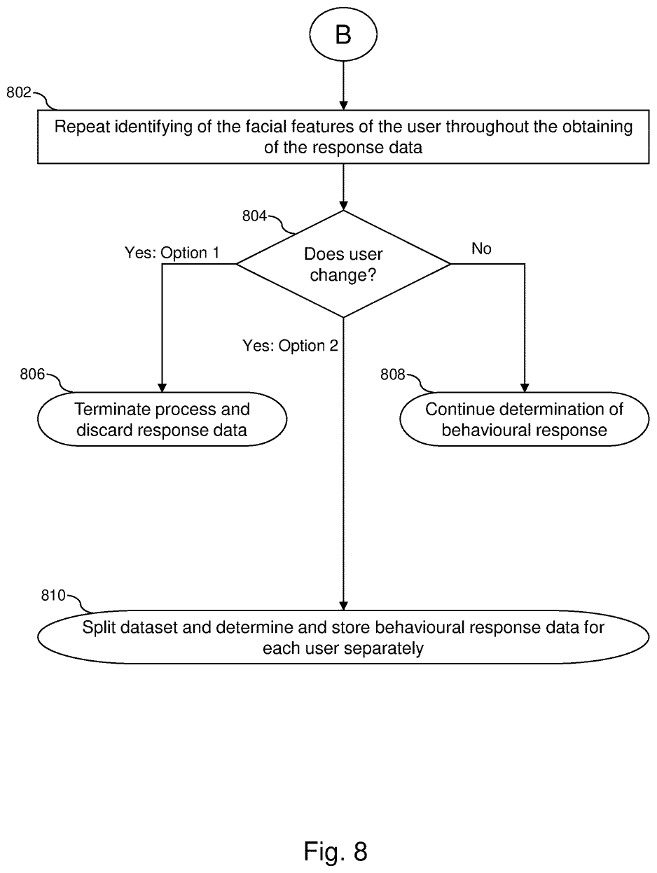

FIG. 8 depicts an additional or alternative continuation of the method of FIG. 4 for responding to a change in the user whose facial images are depicted in the response data.

Operation 802 involves repeating the identifying, by the analysis module 106, of the facial features of the user (as described above in relation to operations 206 and 306 of FIGS. 2 and 3 respectively) throughout the obtaining of the response data by the collection module 104.

Based on the repeatedly identified facial features, the analysis module 106 is configured to determine if the user whose face is depicted in the one or more video streams changes during the collection run of the collection module 104 obtaining the response data.

In effect, therefore, there is a verification operation 804 of determining whether the user changes while the response data is being obtained by the collection module 106.

If it is determined that the user does change while the response data is being obtained by the collection module 104, then an administrator may decide how to proceed. As a first option, the administrator may decide to implement a termination procedure 806. Termination procedure 806 may include terminating, by the termination module 108, the process of determining the user's behavioural response to the consumed media content and discarding any obtained response data from the memory 110.

Alternatively, the administrator may decide, despite the change of user, to continue with the determination or the behavioural responses of the users. This may involve, in operation 810, splitting the obtained response data into separate sections, and separately determining (by the analysis module 106) the behavioural response data for each of the users determined as being depicted in the response data, and thus storing the respectively determined behavioural response data separately in the memory 110. The determination of each of the behavioural response data steams corresponding to each user may be determined in accordance with the methods described above in relation to FIGS. 2 to 7.

Meanwhile, if it is determined that the user does not change while the response data is being obtained by the collection module 104, then the process of determining and storing the behavioural response data stream may continue unamended.

Sometimes it may be beneficial to verify that the obtained response data is of sufficient quality to be able to determine the user's behavioural response to consumed media content based on said response data.

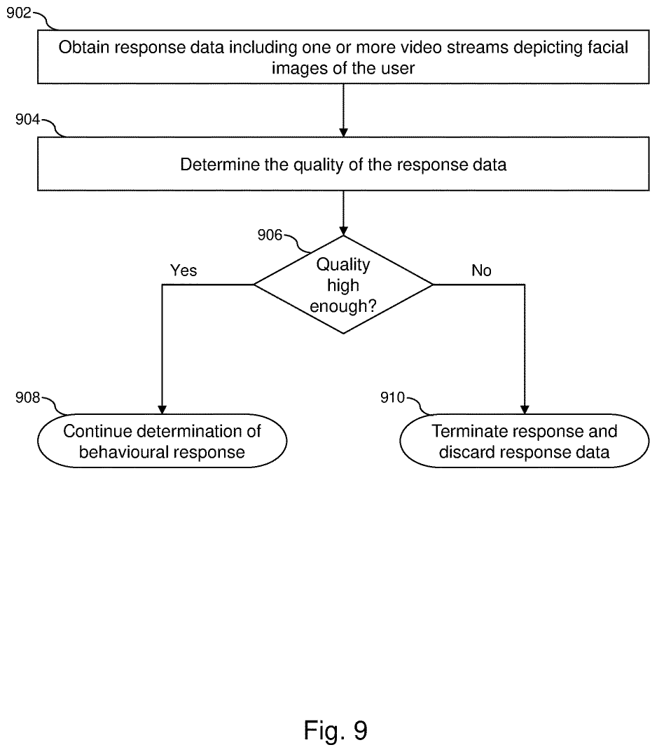

FIG. 9, therefore, shows a quality control method for assessing the quality of the response data.

A first operation 902 involves obtaining, by the collection module 104, the response data that includes one or more video streams depicting facial images of the user or users.

A further operation 904 involves determining, by the analysis module 106, or by a separate quality control module, a quality of the response data.

Determining the quality of the response data may include determining one or more of: a degree of blurriness of the response data, a likelihood that the response data includes at least a portion of spoofed video stream, an extent to which the user's facial features are occluded or clearly depicted in the one or more video streams, and/or a proposition of the facial features of the user that depicted in the one or more video streams. Additionally or alternatively, determining the quality of the response data may include determining a resolution of the one or more video streams.

Determining the quality may involve determining a quality score associated with the response data. The quality score may be a factor that is representative of an aggregate of a variety of factors (including, but not limited to, those listed above) that affect the quality of the response data.

Subsequent to determining the quality of the response data, a further operation 906 involves verifying that the quality of the response data is sufficiently high to be able to reliably determine behavioural response data based thereon.

If it is determined that the quality of the response data is sufficient, then the determination of behavioural response data may continue unaffected, as indicated by operation 908.

Meanwhile, if it is determined that the quality of the response data is insufficient, then a termination process 910 may be implemented. Termination process 910 may include terminating, by the termination module 108, the process of determining the user's behavioural response to the consumed media content and discarding any obtained response data from the memory 110.

FIG. 10 depicts an example of the data structure of the response data 1000 obtained by the collection module 104, and on which the determined behavioural response data stream is based.

The response data 1000 includes one or more video streams 1002 depicting facial images of one or more users consuming media content, for whom a respective behavioural response is to be determined. The response data 1000 may further include audio data 1004 associated with at least one of the one or more video streams.

The response data 1000 may further include metadata 1006. The metadata 1006 may include information indicative of one or more contextual attributes associated with the one or more video streams, e.g., a resolution, time duration, etc.. The metadata 1006 may additionally include information indicative of the type of media content being consumed. For example, the metadata 1006 may include information indicative that the media content is e.g., an advertisement, a video, a picture, a drawing, a sculpture, an exhibit, free-form text, or another type of media content suitable for consumption by a user. This information may be useable when determining the behavioural response of the user to the media content because it may be inferred that different behaviours are indicative of different levels of attentiveness and/or emotional state for different types of media content. For example, the method may involve determining a level of attentiveness based, in part, on a degree of eye movement. In the context of free-form text media content, a large degree of eye movement may be indicative that the user is reading the text, while in the context of a sculpture a large degree of eye movement may be indicative that the user is not interested in the sculpture. Accordingly, determining the behavioural response of the user may involve applying an appropriate model (e.g., a machine learning model) that has been trained to recognise correlations between certain physiological responses (e.g., facial expressions) and the types of media content in such a way as to infer a particular behavioural response based on those correlations.

The metadata 1006 may additionally or alternatively include information related to information indicative of the content depicted in the media content. In this way it may be possible, when synchronising the behavioural response data stream with the media content (as is in operation 602 discussed in relation FIG. 6 above) to identify which particular parts of the consumed media content (in terms of the subject of the media content being consumed by the user) elicit particular behavioural responses, e.g., in the form of an attentiveness or emotional response.

The metadata 1006 may additionally or alternatively include a duration of the media content, or a duration over which the media content is consumed by the user (or users). This information may be useable when synchronising the behavioural response data stream with the media content.

The metadata 1006 may additionally or alternatively include a medium over which the media content is being consumed. For example, the metadata may include information indicative that the media content is being consumed in-person (e.g., an exhibit or gallery), that the media content is being consumed via a personal device, e.g., a mobile device such as a laptop, mobile phone or tablet device, or that the media content is being consumed via a desktop computer. This information may be useable in the determining of the behavioural response of the user (or users) to the media content being consumed because different physiological or physical responses may be expected depending on the medium over which the media content is being consumed. For example, it may be expected that a user consuming media content via a mobile phone will not move their head and face much relative to the camera on the phone (through which the response data is obtained) because the phone screen is relatively small and it is necessary to hold the phone substantially still relative to the user's head so that the user can consume the media content (if they are paying attention to the media content).

FIG. 11 shows an example data structure of a tag 1100 associated with a user. Preferably the tag 1100 is a unique identifier of the user and is indicative of the identity information determined in operation 212 (as discussed in relation to FIG. 2 above). In such examples, the tag may be generated by encoding each element 1102, 1104, 1106 of determined identity information in an appropriate format: e.g., a text string, bit string or similar and concatenating these strings to form an overall user ID string. In some examples, to ensure that each tag is unique, a user ID number 1108 may also be concatenated onto the user ID string. In some examples, the tag 1100 may be generated by encoding each element 1102, 1104, 1106 of determined identity information as a separate vector component making up an overall vector defining the tag 1100.

In some contexts, this user ID string or vector 1102, 1104, 1106, 1108 may be a very long string that consumes an unnecessary amount of storage space in the memory 110. In such cases, it may be advantageous to apply a suitable compression algorithm, or a hash function, to the overall user ID string to generate a more compact tag 1100. The tag 1100 may be decodable by the analysis module 106 to be able to verify the identity information, or to be able to select an appropriate pre-trained model. In some scenarios, where personal information security is particularly important and/or sensitive, it may be preferable for the tag 1100 to be effectively encrypted such that only the analysis module 106 is able to derive a user's identity information from the tag 1100.

In some examples of the methods disclosed herein there may be a plurality of users simultaneously depicted in the one or more video streams that form at least a part of the response data. In such circumstances, it may be preferable to determine the behavioural response for all (or at least a plurality) of the users depicted in the one or more video streams simultaneously or substantially simultaneously. This may be done by implementing the methods described above in relation to FIGS. 2 to 9, in whole or in part, in parallel for each of the users identified as having facial images depicted in the one or more video streams.

In such situations, it may be preferable to select a single combined pre-trained model to analyse all of the response data in one go, instead of processing the response data multiple different times with different pre-trained models.

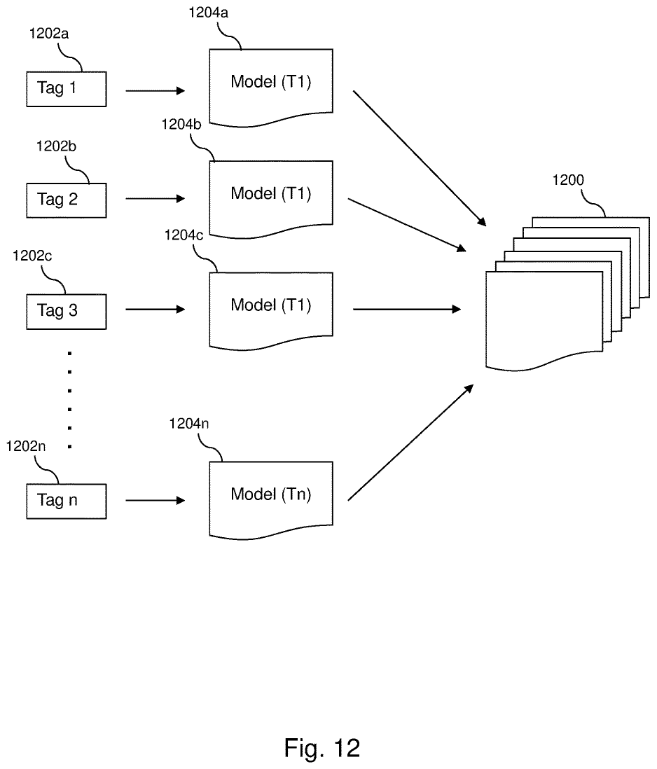

FIG. 12, therefore, depicts an example of the generation of an ensemble model 1200 adapted to determine the behavioural responses of multiple users simultaneously.

Each of the users depicted in the one or more video streams is associated with a respective tag 1202a-n. Based on these tags, the analysis module 106 may be configured to select a respectively appropriate pre-trained model 1204a-n, each specifically adapted (i.e., trained) to determine the behavioural response of the user associated with the corresponding tag 1202a-n.

The analysis module 106 may be further configured to combine or compile each of these selected pre-trained models 1204a-n into a single ensemble model 1200 that is adapted to determine the behavioural response of each of the users associated with the tags 1202a-n simultaneously.

It will be apparent that the methods and systems disclosed herein are best implemented in a computing environment. Accordingly, the present invention encompasses computer-readable media and computer program products that when executed by one or more processors in a computer, or in a networked computing system, cause said computer or networked system to carry out the methods described herein in relation to the systems described herein.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A method of determining user behavioural response during media content consumption, the method steps being executed by one or more processors in a computer and comprising:
obtaining response data including a video stream depicting facial images of a user;
using a facial recognition protocol to obtain an identifier tag for the user from one or more of the facial images depicted in the video stream;
associating the facial images of the user with the identifier tag;
determining a behavioural response of the user to the consumed media content based on the facial features of the user and the associated identifier tag, and
generating a behavioural response data stream using the determined behavioural response, wherein the behavioural response data stream is associated with the identifier tag.

2. The method according to claim 1, further comprising:
storing the identifier tag in a memory;
obtaining further response data including a further video stream depicting facial images of a person;
using a facial recognition protocol to obtain an identifier tag for the person from one or more of the facial images depicted in the video stream; and
comparing the identifier tag for the person with the stored identifier tag.

3. The method according to claim 1, wherein the identifier tag includes information received from the user indicative of their consent for the response data to be used in the determining of a behavioural response

4. The method according to claim 1, wherein the identifier tag is useable as a unique identification label indicative of the user's identity.

5. The method according to claim 1, further comprising:
comparing the identifier tag with a plurality of stored tags, wherein each of the plurality of stored tags is associated with a previously tagged person; and
if the identifier tag corresponds to a stored tag associated with a previously tagged person, terminating the method before determining the behavioural response of the user.

6. The method according to claim 1, further comprising:
comparing the identifier tag with a plurality of stored tags, wherein each of the plurality of stored tags is associated with a previously tagged person; and
if the identifier tag corresponds to a stored tag associated with a previously tagged person, associating the determined behavioural response of the user with a previously determined behavioural response of the user that has been determined on previously obtained response data.

7. The method according to claim 1, further comprising:
determining identity information related to the user, wherein the identifier tag associated with the user includes information indicative of the identity information.

8. (canceled)

9. The method according to claim 1, wherein determining the behavioural response of the user includes determining changes of the behavioural response of the user during the consumption of the media content.

10. The method according to claim 1, further comprising synchronising the behavioural response data stream with the consumed media content.

11. The method according to claim 1, wherein determining the behavioural response of the user includes:
selecting a pre-trained model to be applied to the response data from a group of pre-trained models, wherein the pre-trained model is selected based on the facial features of the user and/or the associated identifier tag; and
applying the pre-trained model to the response data, wherein the pre-trained model is configured to determine the behavioural response of the user based on the facial features of the user.

12. (canceled)

13. The method according to claim 11, the method further comprising:
after determining the behavioural response of the user, verifying the accuracy of the determination; and
updating the pre-trained model based on the verified accuracy.

14. The method according to claim 1, the method further comprising:
repeatedly using the facial recognition protocol to obtain a plurality of identifier tags for the video stream; and
determining, based on the plurality of identifier tags, whether the user depicted in the video stream changes during the obtained response data.

15. The method according to claim 14, wherein if it is determined that the user changes, the method further comprises:
terminating the method and discarding the obtained response data; or
storing the obtained response data in the form of a plurality of response datasets, wherein each response dataset corresponds to response data associated with a different user; and
determining a respective behavioural response of each user to the consumed media content based on the respective facial features of each user and the respective associated identifier tag, wherein each determined behavioural response of the corresponding user is determined as a respective behavioural response data stream that is associated with the corresponding identifier tag.

16. The method according to claim 1, wherein the video stream depicts facial images of a plurality of users, and the method comprises, for each user:
using a facial recognition protocol to obtain an identifier tag for the respective user based on the facial images of said user;
associating the facial images of said user with the respective identifier tag;
determining a respective behavioural response of each user to the consumed media content based on the respective facial features of each user and the respective associated identifier tag; and
generating a respective behavioural response data stream for each user.

17. The method according to claim 16, further comprising: storing each of the associated identifier tags in a memory such that if further response data is obtained including one or more further video streams depicting facial images of any of the same users, the facial images depicted in the one or more further video streams are associated with the corresponding stored identifier tag.

18. The method according to claim 16, further comprising:
tracking movements of the tagged facial images in the one or more video streams to track movements of the plurality of users within an environment imaged in the one or more video streams.

19. The method according to claim 18, wherein determining a behavioural response of each user includes: applying a pre-trained model to the response data, wherein the pre-trained model is configured to determine the behavioural response of each user based, at least in part, on one or more of:
the respectively facial features of said user,
one or more properties associated with the movements of said user through the environment imaged in the one or more video streams, and
a determined behavioural response of another user amongst the plurality of users, wherein the identifier tag associated with the other user is indicative that the other user is similar to said user.

20. (canceled)

21. (canceled)

22. The method according to claim 1, further comprising:
determining a quality of the obtained response data, wherein the quality is indicative of whether the obtained response data is suitable for use in determining the behavioural response of the or each user to the consumed media content; and
if it is determined that the quality is below a predetermined threshold, discarding the obtained response data.

23. A computer-implemented system for determining behavioural response during media content consumption using instructions executed by one or more processors, the system comprising:
a collection module communicatively linked via a network to a plurality of client devices; and
an analysis module communicatively linked to the collection module,
wherein the one or more processors are configured to:
obtain response data including a video stream depicting facial images of a user;
use a facial recognition protocol to obtain an identifier tag for the user from one or more of the facial images depicted in the video stream;
associate the facial images of the user with the identifier tag;
determine a behavioural response of the user to the consumed media content based on the facial features of the user and the associated identifier tag, and
generate a behavioural response data stream using the determined behavioural response, wherein the behavioural response data stream is associated with the identifier tag.

24. A computer-readable medium comprising instructions that, when executed by a computer, cause the computer to:
obtain response data including a video stream depicting facial images of a user;
use a facial recognition protocol to obtain an identifier tag for the user from one or more of the facial images depicted in the video stream;
associate the facial images of the user with the identifier tag;
determine a behavioural response of the user to the consumed media content based on the facial features of the user and the associated identifier tag, and
generate a behavioural response data stream using the determined behavioural response, wherein the behavioural response data stream is associated with the identifier tag.
